(19) United States
(12) Patent Application Publication
(10) Pub. No.: US 2004/0228127 A1
(43) Pub. Date: Nov. 18, 2004

(54) LED clusters and related methods

(76) Inventor: John B. Squicciarini, Aliso Viejo, CA (US)

Correspondence Address: ROBERT D. FISH, RUTAN & TUCKER LLP, 611 ANTON BLVD 14TH FLOOR, COSTA MESA, CA, 92626-1931, US

(21) Appl. No.: 10/845,636

(22) Filed: May 14, 2004

Related U.S. Application Data
(60) Provisional application No. 60/471,128, filed on May 16, 2003.

(51) Int. Cl. F21V 1/00

(52) U.S. Cl. 362/240; 362/545; 362/244

(57) ABSTRACT

Cluster LEDs such as RGB cluster LEDs are formed by housing discrete LEDs within a single lens housing and coupling the LEDs together and to a plug through the use of an interconnect. In some instances the discrete LEDs are directed toward a common point and the lens housings is used to mix the light of the individual LEDs and to set the viewing angle of the cluster LED.

This application claims priority to U.S. application Ser. No. 60/471128, filed May 16, 2003, which is incorporated herein by reference in its entirety.

### FIELD OF THE INVENTION

The field of the invention is remote source lighting.

### BACKGROUND OF THE INVENTION

Remote source lighting systems and methods such as the use of fiber optic and/or prism guides to transmit light are known and provide numerous advantages over more traditional lighting systems and methods. However, known remote source lighting apparatus and methods can still be improved to better achieve such advantages. As such, there is a continuing need for improvements to remote source lighting apparatus and methods.

### SUMMARY OF THE INVENTION

In accordance with an aspect of this invention, red-green-blue (RGB) LEDs having superior illumination and heat dissipation characteristics as described herein are used as remote light sources.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1A is a perspective view of an RGB LED cluster.

FIG. 1B is a perspective view of the RGB LED cluster of FIG. 1A without a lens housing.

FIG. 1C is a perspective view of the lens housing of the cluster of FIG. 1A.

FIG. 2 is a perspective view of a mono-color LED.

FIG. 3A is a top view of a mono-color LED prior to shaping.

FIG. 3B is a top view of the LED of FIG. 3A with dashed lines indicating portions of the LED to be removed.

FIG. 3C is a top view of the LED of FIG. 3A with portions of the encapsulating lens removed.

FIG. 4A is a top view of two LEDs positioned adjacent to each other.

FIG. 4B is a top view of the LEDs of FIG. 4A with dashed lines indicating portions of the LEDs to be removed.

FIG. 4C is a top view of the LEDs of FIG. 4A with portions of the encapsulating lens of each LED removed.

FIG. 5A is a top view of three LEDs positioned adjacent to each other.

FIG. 5B is a top view of the LEDs of FIG. 5A with potions of the encapsulating lens of each LED removed.

FIG. 6 is a perspective view of an RGB LED cluster showing the orientation and point of intersection of the mono-color LEDs.

FIG. 7A is a front side view of a mono-color LED with shaped encapsulating lens.

FIG. 7B is a left side view of the LED of FIG. 7A.

FIG. 7C is an emission pattern of the LED of FIG. 7A.

FIG. 8A is a side view of a lens housing.

FIG. 8B is a side view of a lens housing.

FIG. 8C is a side view of a lens housing.

FIG. 9A is a left side view of a mono-color LED with shaped encapsulating lens.

FIG. 9B is a front side view of the LED of FIG. 9A.

FIG. 10 is a top view of an RGB LED cluster.

FIG. 11 is a perspective view of a plug board adapted to receive a plurality or RGB LED clusters.

### DETAILED DESCRIPTION

RSL systems and illuminators as described herein will preferably comprise one or more LEDs capable of producing a luminous intensity of at least 8000 mcd, and preferably at least 10000 mcd. Unfortunately, previously known Red-Green-Blue (RGB) LEDs are incapable of sustaining luminous intensities higher than 8000 mcd. However, FIGS. 1A to D010 illustrate an RGB LED cluster that can output a sustained luminous intensity of at least 8000 mcd.

In FIGS. 1A-1C, an RGB cluster LED 100 comprises three discrete mono-color LEDs 110, 120, and 130, lens housing 140, interconnect 150, and plug 160 having terminals 161-164. Each LED 110-130 comprises a separate shaped epoxy encapsulation lens and pair of leads where one lead from each LED 110-130 is electrically shorted with terminal 161, which acts as a ground lead. The epoxy encapsulation lens of each LED is preferably separated from interconnect 150 by between 1 mm and 3 mm, and more preferably by 2 mm. LED 100 is referred to as a cluster LED rather than an LED cluster because the mono-color LEDs are all packaged together within a single lens housing such that cluster LED 100 acts more like a single RGB LED than a cluster of LEDs not packaged together. An RGB cluster LED will comprise at least one red, at least one green, and at least one blue mono-color LED. However, alternative cluster LEDs will comprise at least two mono-color LEDs, but the color of each mono-color LED may be chosen based on the colors to be emitted by the cluster LED and thus are not limited to any particular colors.

In FIG. 2, a mono-color LED 210 comprises an anode post 211, a wedge wire bond 212, a cathode post 213, an LED chip 214, a reflector cup 215, a positive lead 216, a negative lead 217, and an epoxy encapsulation lens 218. As shown, in LED 210 the positive lead 216, anode post 211, wire bond 212, LED chip 214, cathode post 213, and negative lead 216 are electrically coupled together to allow electrical current to flow into and out of LED chip 214; the anode post 211, LED chip 214, reflector cup 215, and cathode post 213 are encapsulated within the LED's epoxy encapsulation lens 218; and the positive and negative leads 216-217 extend out of the LED's epoxy encapsulation lens 218.

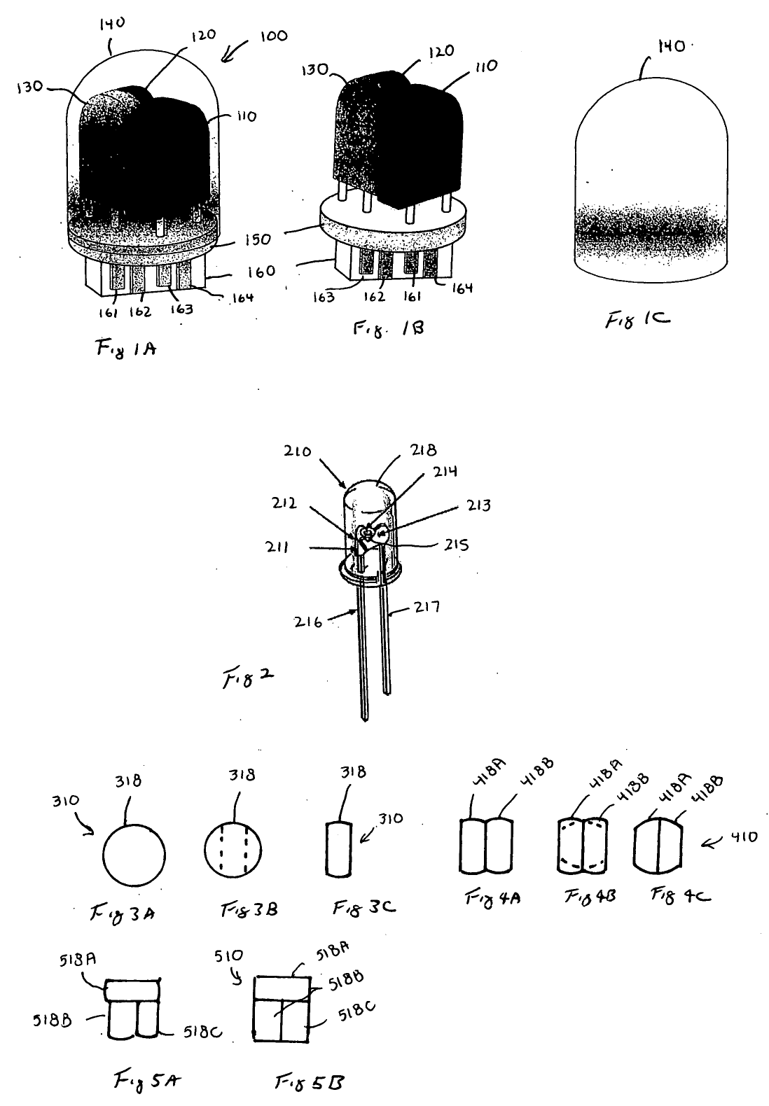

It is preferred that LEDs 110-130 be shaped as shown in FIG. 1A. The LED of FIG. 2 can be modified to have such a shape by removing portions of the encapsulation lens 218 in the manner illustrated in FIGS. 3A-3C. In FIG. 3A, lens 318 begins with a circular shape when viewed from the top. In FIG. 3B, the dashed lines split the encapsulation lens into three parts with the intent that the outer parts are to be removed. In FIG. 3C, LED 318 is shown after the outside portions have been removed and is left with the shape of the LEDs of FIG. 1A. The portions removed from the LED are the otherwise empty portions on the to the sides of the LED chip, reflector cup, etc. so that the LED 310 will still function without the removed portions.

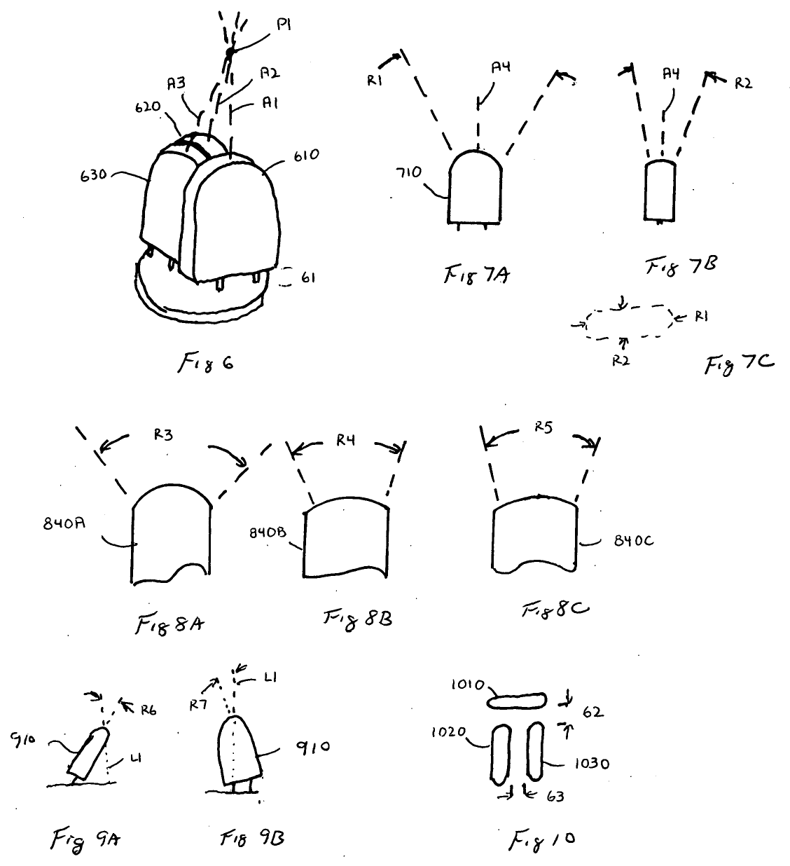

In some instances, clusters of LEDs will be shaped to have a specific footprint such as shown in FIGS. 4C and 5B. In FIGS. 4A-4C a cluster 410 of two LEDs is formed by positioning the LEDs 418A and 418B, previously shaped as shown in FIGS. 3A-3C, adjacent to each other and then removing portions of each of the two LEDs 418A and 418B to give the cluster 410 a more circular shape. In FIGS. 5A-5B a cluster 510 of three LEDs 518A, 518B and 518C is formed by positioning the LEDs 518A, 518B and 518C, previously shaped as shown in FIGS. 3A-3C, adjacent to each other as shown in FIG. 5A and squaring them off to provide the rectangular cluster shape of FIG. 5B.

In preferred LED clusters each mono-color LED will be oriented such that light emitted by it will be centered on an axis, and each such directional axis of the LEDs will be intersected at a common point. This is illustrated in FIG. 6 in which mono-color LEDs 610-630 each have a directional axis DA1-DA3 that intersect at point DP1. As such, a method of forming such an LED cluster will generally comprise one or more steps directed to orienting the mono-color LEDs such that their directional axis intersect or are as close to intersecting as reasonably possible.

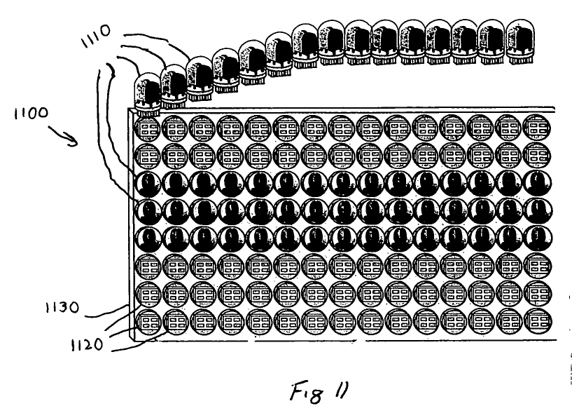

FIGS. 7A-7C, showing front and side views of a mono-color LED 710 and the emission pattern of LED 710, illustrate a possible affect of shaping the encapsulation lens LED 710 having a directional axis DA4. That effect is that light emitted from the top portion of the LED will be have a non-circular emission pattern as shown in FIG. 7C that has a smaller area than the emission pattern the LED would have if it was not shaped as described in FIGS. 3A-3C. As a result the energy emitted from the top of the LED is spread across a smaller area than for a standard LED. It is contemplated that modifying the LED encapsulation lens of a mono-color LED to have a reduced emission pattern contributes to the increased intensity provided by the cluster LED any such mono-color LED is a part of. It is contemplated that additional intensity increases and/or power distribution characteristics can be obtained by coating the sides of each mono-color LED within a cluster, possibly with a reflective and/or thermally conductive coating, so as to cause more of the light emitted by the LED's LED chip (such as that which is not directed through the top by a reflector cup or which results from internal reflection as light passes out of the LED) to be directed out of the top of the LED and/or to cause the LED to dissipate heat faster.

As illustrated by FIGS. 8A-8C the lens housing of a cluster LED can be selected to obtain a particular viewing angle for the cluster LED of which it is a part. As such, the angles DR3-DR5 of lens housing 840A-840C of FIGS. 8A-8C are all different. In preferred embodiments the lens housing will facilitate the formation of an LED having a viewing angle of less than or equal to ten degrees, and will also somewhat diffuse the light of the mono-color LEDs within the cluster LED such that the light emitted by the cluster LED seems to come from a single LED rather than a cluster of individual LEDs.

FIG. 9A is a left side view of a mono-color LED 910 with shaped encapsulating lens. FIG. 9B is a front side view of the LED of FIG. 9A.

In some embodiment the mono-color LEDs of a cluster LED may be separated by gaps for heat dissipation and/or light distribution purposes. In FIG. 10 a three mono-color cluster LED 1000 comprises mono-color LEDs 1010-1030 separated by a plurality of gaps DG2-DG3. It is contemplated that in some instances each gap will provide a separation between mono-color LEDs of between 0.1 and 3.0 mm.

FIG. 11 illustrates a plug board for use with cluster LEDs comprising plugs. In FIG. 11, filled plugboard assembly 1100 comprises a plurality of cluster LEDs 1110, a plurality of plugs 1120, and substrate 1130. Removal of cluster LEDs 110 would result in an unfilled plugboard assembly. It is contemplated that unfilled plugboard assemblies can be manufactured such that they can subsequently be trimmed to a desired shape and filled with the cluster LEDs. In such instances the spacing between plugs 1120 and the structure of substrate 1130 between plugs 1120 may be modified to facilitate removing portions of the plugboard. Plugboard assemblies will generally comprise one or more connectors that permit power and possibly control signals to each plug, will generally comprise conductive traces for routing power and control signals, may comprise multiple conductive and dielectric layers to facilitate routing, and may comprise one or more control circuits and/or power circuits.

### ADDITIONAL EMBODIMENTS

LED Controllers

LED controllers, particularly controllers for use with cluster LEDs such as RGB cluster LEDs may facilitate selection and retention of an intensity and/or color to be emitted by the LEDs or cluster LEDs it controls.

In some instances a controller will, generally on receipt of a signal, cause the cluster LED to cycle in a continuous or stepwise fashion through the colors it can emit, typically by controlling the amount of power provided to the discrete LEDs contained within the cluster LED.

In some instances a controller will, generally on receipt of a signal, cause the cluster LED to cycle in a continuous or stepwise fashion through various intensities, possibly while attempting to maintain the current color of the cluster LED.

In some instances a controller, generally on receipt of a signal, will record the current state of the inputs being provided to a cluster LED such that the color and/or intensity of the cluster LED can be recreated at a later time. In such instances, the controller might adjust the inputs of the cluster LED to the retained state whenever the controller is initially provided power or upon receipt of an appropriate signal.

Running Lights

A vehicle having one or more RLSs as running lights. In one embodiment the trailer of a tractor-trailer truck will have at least one RLS extending along the length of each side of the trailer. The RLS may be server a purely decorative purpose or may be controlled in conjunction with indicator lights on the trailer. As an example the RLS may be set to constantly emit light at night or when external light is reduced, but controlled to increase in intensity when brake lights light, and/or to flash when turn indicators are being used.

In another embodiment a boat or other water craft will have at least one RLS extending along each side with the color of each RLS differing between side and being selected to indicate to persons seeing the boat a characteristic of how the boat is being operated such as its current direction. As an example, red and green RLSs can be used to identify the port and starboard sides of the boat to allow the direction the boat is traveling to be determined by someone observing the boat in operation.

Still other embodiments of “vehicles” than can include running lights are bicycles, tricycles, trailers, hospital beds, and so forth.

Police Motorcycle

A police motorcycle or other police or emergency vehicle may have one or more RLSs that are used to replace and/or supplement the indicator/warning lights normally found on such a vehicle. In many instances the colors of any RLS will be included to match those typically found on such vehicles such as the use of red and blue on police vehicles. In some instances RLSs will comprise a plurality of segments extending along the length of the vehicle wherein the color of the RLS varies between segments. As an example, a police motorcycle may comprise an RLS on each side of the motorcycle wherein each RLS comprises a plurality of segments where adjacent segments alternately emit red and blue light.

Safety Helmet

A safety helmet such as a helmet used to provide head protection (often while biking, skating, snowboarding, etc.) comprising an RLS. In preferred embodiments the RLS will be coupled in or to the external surface of the helmet so as to cause the helmet to emit light in a desired pattern and color. In some instances the helmet may comprise one or more controllers that allow a wearer to select the color and/or intensity to be emitted by the RLS. In some instances the RLS may emit a plurality of colors and may have multiple segments with individual segments being individually controllable. In some embodiments the RLS may be programmable so as to cause light and intensity levels to change in a programmed pattern over time. Some embodiments may comprise one or more cluster LEDs.

Variable Color Multi-Led Light Source

A light source comprising a plurality of LEDs, a controller, and at least one input device wherein the controller is adapted to adjust the color of any light emitted by the light source by controlling the plurality of LEDs in response to one or more signals received from the input device.

Multi-Mode RLS

A side emitting fiber assembly is adapted to transmit both data signals and visible light. In a preferred embodiment, the assembly will be part of an RLS used in outdoor lighting (such as lights used to illuminate a planter or sidewalk) wherein both light and control signals are transmitted along the RLS.

Thus, specific embodiments, applications, and methods relating to remote source lighting systems have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A cluster LED comprising at least two mono-color LEDs positioned within a single lens housing.

2. The cluster LED of claim 1 wherein each mono-color LED comprises a separate epoxy encapsulation lens.

3. The cluster LED of claim 2 wherein at least one LED emits light in a non-circular pattern.

4. The cluster LED of claim 3 further comprising an interconnect and a plug wherein the interconnect electrically and physically couples the plug to the mono-color LEDs and physically couples the plug to the lens housing, and the plug comprises at least three terminals wherein at least one terminal is shared by one lead from each of the mono-color LEDs.

5. The cluster LED of claim 4 wherein each epoxy encapsulation lens is separated from interconnect by 2 mm.

6. The cluster LED of claim 5 having a viewing angle less than or equal to ten degrees.

7. The cluster LED of claim 6 having a luminous intensity of at least 8000 mcd.

8. The cluster LED of claim 7 wherein each mono-color LED comprises an anode post, a cathode post, a cluster LED chip, a reflector cup, a positive lead, and a negative lead wherein:
the positive lead, anode post, LED chip, cathode post, and negative lead are electrically coupled together;
the anode post, LED chip, reflector cup, and cathode post are encapsulated within the cluster LED's epoxy encapsulation lens; and
the positive and negative leads extend out of the cluster LED's epoxy encapsulation lens.

9. An RGB cluster LED having a luminous intensity of at least 8000 mcd.

10. The cluster LED of claim 9 comprising at least three discrete LEDs.

11. The cluster LED of claim 10 wherein each discrete LED has a luminous intensity of at least 8000 mcd.

12. The cluster LED of claim 10 wherein each discrete LED has a luminous intensity of less than 8000 mcd.

13. The cluster LED having a luminous intensity of at least 10000 mcd.

14. The cluster LED of claim 9 having an eight-degree viewing angle.
